(19) United States
(12) Patent Application Publication
(10) Pub. No.: US 2023/0038575 A1
(43) Pub. Date: Feb. 9, 2023

(54) COATED ZIRCONIA FINE PARTICLE AND METHOD FOR PRODUCING THE SAME

(71) Applicant: Kanto Denka Kogyo Co., Ltd., Chiyoda-ku, Tokyo (JP)

(72) Inventors: Yuki GOTO, Shibukawa city, Gunma (JP); Hidehiko IINUMA, Chiyoda-ku, Tokyo (JP); Tetsuya FUKASAWA, Shibukawa city, Gunma (JP)

(21) Appl. No.: 17/788,830

(22) PCT Filed: Dec. 23, 2020
(86) PCT No.: PCT/JP2020/048126

§ 371 Date: Jun. 24, 2022

(30) Foreign Application Priority Data
Dec. 24, 2019 (JP) 2019-233360

(51) Int. Cl. C01G 25/00; C01G 25/02; C04B 35/486

(52) U.S. Cl. CPC C01G 25/006; C01G 25/02; C04B 35/486; C01P 2004/64; C01P 2006/12

(57) ABSTRACT

Coated zirconia fine particle containing a zirconia fine particle and a coating layer coating the surface of the fine particle. The coating layer includes one or more metal elements selected from Mg, Ca, Al and rare-earth elements, and the coated zirconia fine particle has an average particle size of 3 to 100 nm and a specific surface area of 20 to 500 m²/g.

### FIELD OF THE INVENTION

The present invention relates to a coated zirconia fine particle and a method for producing the same.

### BACKGROUND OF THE INVENTION

Zirconia (ZrO₂) has many excellent characteristics such as high refractive index, high strength, toughness, high abrasion resistance, high lubricity, high corrosion resistance, high oxidation resistance, insulation properties, low thermal conductivity, high transparency in the visible spectrum and the like, and is hence used for various applications such as automotive exhaust catalysts, capacitors, grinding balls, dental materials, glass additives, thermal barriers, solid electrolytes, optical materials and the like.

While zirconia is used to produce various articles by, for example, molding and sintering fine particles thereof, it alone has a tetragonal crystal structure at high temperatures and a monoclinic crystal structure at low temperatures, and therefore poses the problem that it expands and contracts in volume with temperature changes, causing the sintered products to be cracked and susceptible to fracture. Thus, there is generally taken a method of forming a solid solution of zirconia and a stabilizer such as yttria (Y₂O₃), calcia (CaO), magnesia (MgO), ceria (CeO₂) or the like, thereby preventing the phase transitions. Zirconia made to be partially stabilized with a stabilizer added is called partially stabilized zirconia.

Partially stabilized zirconia is produced by various methods such as neutralization method, hydrolysis method, hydrothermal synthesis, hydrolysis of alkoxide, chemical vapor deposition, spray pyrolysis or the like depending on producing methods of zirconia.

JP-A 2008-24555 discloses a method for producing a zirconia fine powder which comprises one or more of yttria, calcia, magnesia and ceria as stabilizers, the method comprising adding a compound of yttrium or the like as a stabilizer to a hydrated zirconium sol, drying, and preliminarily sintering in the range of 1000 to 2000° C.

JP-A 2010-137998 discloses a method for producing a partially stabilized zirconia ceramic which comprises zirconia and yttria in predetermined ranges, the method comprising heat-treating a composite formed of powdered yttria fine particles or yttrium salts uniformly dispersed in zirconium hydroxide as a starting material including Zr in the temperature range of 1100 to 1400° C., thereby obtaining zirconia, grinding it to obtain a ceramic powder, and molding and sintering the powder.

JP-A 2015-221727 discloses a method for producing a predetermined zirconia sintered product of a yttria concentration of 2 to 4 mol % comprising 0.05 to 3 mass % of alumina, the method comprising molding and preliminarily sintering at 1100 to 1200° C., a zirconia powder of a yttria concentration of 2 to 4 mol % comprising an aluminum compound equivalent to 0.05 to 3 mass % of alumina, the zirconia powder having an average secondary particle size of 0.1 to 0.4 μm and a ratio of average secondary particle size/primary average particle size measured with electronic microscope of 1 to 8, and subjecting the obtained preliminarily-sintered product to hot isostatic pressing at a pressure of 50 to 500 MPa and a temperature of 1150 to 1250° C.

JP-A 2009-227507 discloses a method for producing a zirconia composite fine particle comprising adding an alkali carbonate solution to an acidic zirconia dispersion which comprises a rare-earth element ion and/or an alkaline earth metal ion to produce a neutralized precipitation, then drying this neutralized precipitation, heat-treating this dried neutralized precipitation at a temperature of 400° C. or more and 600° C. or less, and then washing to remove an alkali carbonate component.

JP-A H5-170442 discloses a method for producing a crystalline zirconia sol in which a rare-earth element oxide, calcia or magnesia forms a solid solution with zirconia, the method comprising mixing in advance a solution of a zirconium salt and a solution of a salt of one selected from a rare-earth element, calcium or magnesium, adding the mixed solution into a basic solution or a slurry of a basic substance, heating the obtained slurry at a temperature of 80 to 200° C., adding an acid thereto, and thereafter separating and washing.

JP-A 2017-154927 discloses a zirconium oxide nanoparticle coated with a carboxylic acid, the zirconium oxide nanoparticle comprising yttrium as well as comprising at least one of transition metals other than rare-earth elements.

### SUMMARY OF THE INVENTION

The methods of JP-A 2008-24555, JP-A 2010-137998, JP-A 2015-221727 and JP-A 2009-227507, which utilize neutralization method and/or hydrolysis method and require sintering at high temperatures to form a solid solution, are more likely to produce particles with non-uniform particle shapes due to particle growth and poor dispersibility.

On the other hand, the methods of JP-A H5-170442 and JP-A 2017-154927, which utilize hydrothermal synthesis and do not require a sintering process, can produce particles with a fine particle size, and are considered to be advantageous in obtaining zirconia fine particles on the order of tens of nanometers. However, as a yttrium salt often utilized as a stabilizer is generally less soluble than a zirconium salt, it is difficult for a method utilizing hydrothermal synthesis to uniformly mix zirconium and yttrium at the atomic levels, leading to the tendency of yttria to be unevenly distributed in industrial-scale production. In addition, reactions take a long time, leaving issues in terms of productivity.

In view of such situations, the present invention provides a stable zirconia fine particle and a simple method for producing the same.

The present invention relates to a coated zirconia fine particle containing a zirconia fine particle and a coating layer coating the surface of the fine particle,

wherein the coating layer includes one or more metal elements selected from Mg, Ca, Al and rare-earth elements, and

the coated zirconia fine particle has an average particle size of 3 to 100 nm and

a specific surface area of 20 to 500 m²/g.

Further, the present invention relates to a method for producing coated zirconia fine particles including reacting, in an aqueous dispersion containing zirconia fine particles, ions of one or more metal elements selected from Mg, Ca, Al and rare-earth elements with an additive that reacts with the ions to form a water-insoluble compound, and precipitating a compound including the metal elements on the surface of the zirconia fine particles to obtain the coated zirconia fine particles.

According to the present invention, a stable coated zirconia fine particle and a simple method for producing the same are provided.

Compared to conventional zirconia fine particles, the coated zirconia fine particle of the present invention has the advantage that a high-density sintered product with cracking and fracture suppressed can be obtained therefrom through a sintering process, and is hence suitable for applications such as various ceramic materials, dental materials, capacitors, coating materials or the like. In addition, the coated zirconia fine particle of the present invention, which can be produced by a simple method, can reduce production costs and is useful for industrial-scale production.

### BRIEF DESCRIPTION OF DRAWINGS

FIG. 1 is a transmission electron microscopy (TEM) image of coated zirconia fine particles obtained in example 2.

FIG. 2 shows scanning electron microscope/energy dispersive X-ray spectroscopy (SEM-EDX) images showing the elemental distribution of zirconium and yttrium in the coated zirconia fine particles obtained in example 2 and those obtained in comparative example 2.

### EMBODIMENTS OF THE INVENTION

### [Coated Zirconia Fine Particle]

The present invention relates to a coated zirconia fine particle containing a zirconia fine particle and a coating layer coating the surface of the fine particle, wherein the coating layer includes one or more metal elements selected from Mg, Ca, Al and rare-earth elements, and the coated zirconia fine particle has an average particle size of 3 to 100 nm and a specific surface area of 20 to 500 m²/g.

The zirconia fine particle has a specific surface area of preferably 20 to 500 m²/g, more preferably 40 to 200 m²/g and further preferably 70 to 150 m²/g. When the zirconia fine particle has a specific surface area of 20 m²/g or more, the obtained coated zirconia fine particle has a moderately suppressed particle size, and a high-density sintered product is more likely to be obtained. In addition, the stabilization effect of the metal elements in the coating layer tends to be easily expressed. When the zirconia fine particle has a specific surface area of 500 m²/g or less, the obtained particle has a moderately large particle size, with cohesive force being not excessively large, leading to easy monodisperse at surface coating and an improved filling property at molding using the coated zirconia fine particle.

Here, the specific surface area of the zirconia fine particle can be measured by the BET method through adsorption and desorption of nitrogen gas for a sample degassed at 150° C. with a BET specific surface area analyzer, for example, a full automatic BET specific surface area analyzer (Macsorb® HM model-1210) manufactured by Mountech Co., Ltd.

The zirconia fine particle has an average particle size of preferably 3 to 100 nm, more preferably 5 to 50 nm and further preferably 7 to 20 nm. In the present invention, the average particle size of the zirconia fine particle can be determined from the average value of the particle sizes of 200 or more arbitrary particles measured on the basis of observations of a TEM image with a magnification of 200,000 times obtained by a transmission electron microscopy.

The coated zirconia fine particle of the present invention has a coating layer including one or more metal elements selected from Mg, Ca, Al and rare-earth elements on the surface of the zirconia fine particle.

The one or more metals selected from Mg, Ca, Al and rare-earth elements contribute to the stabilization of the zirconia fine particle.

The rare-earth element is preferably Y (yttrium).

The coating layer may contain a compound including one or more metal elements selected from Mg, Ca, Al and rare-earth elements (hereinafter also referred to as coating compound).

The coating layer may contain one or more selected from hydroxides of one or more metal elements selected from Mg, Ca, Al and rare-earth elements, carbonate salts of the metal elements, and oxides of the metal elements.

The coating layer preferably may contain one or more selected from hydroxides of one or more metal elements selected from Mg, Ca, Al and Y, carbonate salts of the metal elements, and oxides of the metal elements.

The coating layer preferably contains Y, and more preferably contains a yttrium compound such as yttrium hydroxide or the like and further a hydroxide.

The metal elements added to the zirconia fine particle suppress the phase transition from tetragonal to monoclinic and improve the strength, durability and dimensional accuracy. The amount of the metal elements can be adjusted from this viewpoint. In the present invention, the amount of the coating compound in the coating layer is, for example, preferably 3 to 45 mol %, more preferably 5 to 40 mol %, further preferably 6 to 36 mol % and furthermore preferably 12 to 28 mol % relative to the amount of zirconia in the zirconia fine particle. The coating compound in the coating layer in an amount equal to or more than the above lower limit moderately increases the tetragonal ratio in the crystal structure after high-temperature sintering, enhancing the effect of suppressing cracking and fracture of a sintered product, as well as facilitating the production of a molded product. Further, the metal elements in the coating layer in an amount equal to or less than the above upper limit can maintain the bending strength and fracture toughness, as well as hardly forming an impurity phase derived from a stabilizer after high-temperature sintering to improve the strength, insulation properties and other properties of a sintered product. Note that the amount of the coating compound in the coating layer can be measured and determined by the XRF spectrometry or the like. Further, it can be calculated and determined on the basis of an estimated coating compound identified in the light of the type and preparation amount of a compound used for coating, the type of a neutralizing agent for neutralizing the compound if any, or the like.

The coated zirconia fine particle of the present invention has an average particle size of 3 to 100 nm, preferably 5 to 50 nm and more preferably 7 to 20 nm. The average particle size of the coated zirconia fine particle is determined from the average value of the particle sizes of 200 or more arbitrary particles measured on the basis of observations of a TEM image with a magnification of 200,000 times obtained by a transmission electron microscopy. A composition containing the coated zirconia fine particle with the particle size controlled can improve its transparency. Further, the particle has excellent low-temperature sintering properties.

The coated zirconia fine particle of the present invention has a specific surface area of 20 to 500 m²/g, preferably 40 to 200 m²/g and more preferably 70 to 150 m²/g. The coated zirconia fine particle with a specific surface area of 20 m²/g or more has a moderately suppressed particle size, so that a high-density sintered product is more likely to be obtained. In addition, the stabilization effect of the metal elements in the coating layer tends to be easily expressed. Further, the coated zirconia fine particle with a specific surface area of 500 m²/g or less has a moderately large particle size and does not cause excessively large cohesive force, so that the filling property at molding is improved.

The coated zirconia fine particle of the present invention can be suitably used for various ceramic materials, dental materials, capacitors, coating materials or the like.

### [Method for Producing Coated Zirconia Fine Particles]

The present invention relates to a method for producing coated zirconia fine particles including reacting, in an aqueous dispersion containing zirconia fine particles, ions of one or more metal elements selected from Mg, Ca, Al and rare-earth elements with an additive that reacts with the ions to form a water-insoluble compound, and precipitating a compound including the metal elements (coating compound) on the surface of the zirconia fine particles to obtain the coated zirconia fine particles. The matters mentioned in the coated zirconia fine particle of the present invention can be appropriately applied to the producing method of the present invention. The coated zirconia fine particle of the present invention can be obtained by the producing method of the present invention. For example, preferable modes of the raw material zirconia fine particles and the metal elements are the same as those mentioned in the coated zirconia fine particle of the present invention.

Examples of the additive include, for example, an alkali agent. Examples of the alkali agent include, for example, hydroxides such as NaOH, KOH and the like, carbonate salts such as Na₂CO₃, K₂CO₃, ammonium carbonate, NaHCO₃, KHCO₃ and the like, ammonia and others. While these alkali agents can be used in the form of aqueous solutions, powders, solids and crystals, aqueous solutions are preferable for ease of operation. In addition, aqueous ammonia solution can also be used as the alkali agent. When the alkali agent is used in an aqueous solution, the concentration is preferably 5 to 50 mass % and more preferably 10 to 30 mass %.

In the present invention, the ions of the metal elements can be introduced into the aqueous dispersion of zirconia fine particles, for example, by mixing an aqueous solution of a compound including the metal elements to the aqueous dispersion.

In the present invention, the ions can be reacted with the additive by mixing the aqueous dispersion, the aqueous solution of a compound including the metal elements and the additive together. In that case, the aqueous solution of a compound including the metal elements and the additive are used such that the amount of the coating compound formed of the compound and the additive is preferably 3 to 45 mol %, more preferably 5 to 40 mol %, further preferably 6 to 36 mol % and furthermore preferably 12 to 28 mol % relative to the amount of zirconia in the zirconia fine particles by the theoretical maximum value.

In the present invention, after obtaining the coated zirconia fine particles, the additive can be removed from the coated zirconia fine particles. For example, after obtaining the coated zirconia fine particles, the coated zirconia fine particles can be washed with water.

In the present invention, the obtained coated zirconia particles can be dried at a temperature that does not cause sintering of the coated zirconia fine particles, for example, 200° C. or less.

In the present invention, the particle surface of the zirconia fine particles can be uniformly coated with the metal compound by adding and uniformly mixing the alkali agent to the aqueous dispersion containing the zirconia fine particles, and thereafter adding the aqueous solution of a compound including the metal elements to cause a neutralization reaction.

Further, in the present invention, the particle surface of the zirconia fine particles can be uniformly coated with the metal compound by adding the aqueous solution of a compound including the metal elements to the aqueous dispersion containing the zirconia fine particles, and thereafter adding the alkali agent to cause a neutralization reaction.

Further, in the present invention, the particle surface of the zirconia fine particles can be uniformly coated with the metal compound by simultaneously adding the aqueous solution of a compound including the metal elements and the alkali agent to the aqueous dispersion containing the zirconia fine particles to cause a neutralization reaction.

One example of the method for producing coated zirconia fine particles of the present invention is explained.

First, zirconia fine particles are uniformly dispersed in water. It is desirable for the uniform dispersion of the zirconia fine particles that pH adjustment be carried out and a dispersing device such as an ultrasonic homogenizer, a planetary ball mill, Henschel Mixer®, a colloid mill, a wet jet mill, a wet bead mill or the like be used. Further, a mechanical stirrer or the like can also be used.

The aqueous dispersion of the zirconia fine particles thus obtained is mixed with a composition that contains ions of one or more metal elements selected from Mg, Ca, Al and rare-earth elements and water. The composition is preferably an aqueous solution of a compound, for example, a salt of the metal elements. Examples of the salt including the metal elements include inorganic salts such as a sulfate, a nitrate, a chloride salt and the like. Further, an organic compound such as a metal alkoxide or the like can be used. The inorganic salts are preferable for solubility or availability. The aqueous solution has a concentration of preferably 0.001 to 10 mol/L and more preferably 0.01 to 5 mol/L.

Next, an additive that reacts with the ions to form a water insoluble compound is mixed to the mixture of the aqueous dispersion of the zirconia fine particles and the composition that contains ions of the metal elements and water, preferably an aqueous solution of a compound (for example, salt) including the metal elements.

Examples of the additive include the above alkali agents, for example, aqueous solutions of the alkali agents.

When a salt including the metal elements is used, the alkali agent is added in such an amount that makes the degree of neutralization of the salt, for example, 0.8 or more.

The temperature at which the alkali agent is added is not particularly limited, but may be 100° C. or less, for example.

In the present invention, it can be confirmed, for example, from the state of the zirconia fine particles shown in TEM images that the surface of the zirconia fine particles is coated with the compound including the metal elements.

The aqueous dispersion that includes the zirconia fine particles uniformly coated with the metal compound is appropriately subjected to filtration, washing with water, drying, crushing and other processes to obtain the coated zirconia fine particles. In one example, the coating layer is composed of hydroxides or carbonates of Mg, Ca, Al and rare-earth elements and in a non-crystalline state. Further, the coating layer may be heat-treated to be in an oxide crystal state.

The coated zirconia fine particle of the present invention can be used in the form of a powder, a dispersion, a nanocomposite or the like. Examples of the dispersion include one made with water or an organic compound as a dispersion medium. Further, examples of the nanocomposite include a nanocomposite made of the particles uniformly dispersed in an organic compound such as a monomer, an oligomer, a resin or the like.

One example of the producing method of the present invention is a method for producing coated zirconia fine particles including, mixing an aqueous dispersion of zirconia fine particles and an aqueous solution of water-soluble salts of one or more metal elements selected from Mg, Ca, Al and rare-earth elements to obtain a mixture, mixing an alkali agent to the mixture such that the mixture has a pH of 8 to 13 and preferably 12 to 13, and precipitating a compound including the metal elements on the surface of the zirconia fine particles to obtain the coated zirconia fine particles. In this case, the alkali agent can be added such that the degree of neutralization of the water-soluble salts is 0.8 or more. Further, in the present invention, the coated zirconia particles can be washed with water until the detection amount of the alkali agent is 0.01 mass % or less. Examples of the water-soluble salts include one with a solubility in water at 20° C. of 5.0 g or more relative to 100 g of water.

According to the present invention, provided is a method for producing zirconia fine particles including reacting, in an aqueous dispersion containing zirconia fine particles, ions of one or more metal elements selected from Mg, Ca, Al and rare-earth elements with an additive that reacts with the ions to form a water-insoluble compound.

According to the present invention, provided is a method for producing zirconia fine particles including, mixing an aqueous dispersion of zirconia fine particles and an aqueous solution of water-soluble salts of one or more metal elements selected from Mg, Ca, Al and rare-earth elements to obtain a mixture, and mixing an alkali agent to the mixture such that the mixture has a pH of 8 to 13 and preferably 12 to 13. The aqueous solution may contain the water-soluble salts in a concentration of 0.001 to 10 mol/L. Further, the alkali agent can be added such that the degree of neutralization of the water-soluble salts is 0.8 or more. Further, in the present invention, the coated zirconia particles can be washed with water until the detection amount of the alkali agent is 0.01 mass % or less. Examples of the water-soluble salts include one with a solubility in water at 20° C. of 5.0 g or more relative to 100 g of water.

According to the present invention, provided is a method for producing a zirconia sintered product including, a step of producing the coated zirconia fine particle by the method of the present invention, and a step of sintering the produced coated zirconia fine particle. The matters mentioned in the coated zirconia fine particle and the method for producing coated zirconia fine particles of the present invention can be appropriately applied to this method for producing a zirconia sintered product. The coated zirconia fine particle can be sintered in accordance with a publicly-known method for sintering a zirconia fine particle in view of the application of the sintered product or the like. One example is a method of sintering at 1300 to 1600° C. for 1 to 15 hours.

According to the present invention, provided is a method for producing a dispersion of coated zirconia fine particles including, a step of dispersing the coated zirconia fine particles of the present invention in a dispersion medium (hereinafter also referred to as dispersion medium for use in dispersions). The matters mentioned in the coated zirconia fine particle and the method for producing coated zirconia fine particles of the present invention can be appropriately applied to this method for producing a dispersion of coated zirconia fine particles.

Further, according to the present invention, provided is a method for producing a nanocomposite including, a step of dispersing the coated zirconia fine particles of the present invention in a dispersion medium (hereinafter also referred to as dispersion medium for use in nanocomposites). The matters mentioned in the coated zirconia fine particle and the method for producing coated zirconia fine particles of the present invention can be appropriately applied to this method for producing a nanocomposite.

In the method for producing a dispersion of coated zirconia fine particles and the method for producing a nanocomposite of the present invention, the coated zirconia fine particles of the present invention may be treated with a surface treatment agent. Examples of the surface treatment agent can include but are not limited to those listed below.

For example, a (meth)acryloyloxy silane coupling agent, a vinyl silane coupling agent, an epoxy silane coupling agent, an amino silane coupling agent, an ureido silane coupling agent or the like can be used.

Examples of the (meth)acryloyloxy silane coupling agent include 3-(meth)acryloyloxypropyltrimethylsilane, 3-(meth)acryloyloxypropylmethyldimethoxysilane, 3-(meth)acryloyloxypropyltrimethoxysilane, 3-(meth)acryloyloxypropylmethyldiethoxysilane and 3-(meth)acryloyloxypropyltriethoxysilane. Examples of an acryloxy silane coupling agent include 3-acryloxypropyltrimethoxysilane.

Examples of the vinyl silane coupling agent include allyltrichlorosilane, allyltriethoxysilane, allyltrimethoxysilane, diethoxymethylvinylsilane, trichlorovinylsilane, vinyltrichlorosilane, vinyltrimethoxysilane, vinyltriethoxysilane and vinyltris(2-methoxyethoxy)silane.

Examples of the epoxy silane coupling agent include diethoxy(glycidyloxypropyl)methylsilane, 2-(3,4-epoxycyclohexyl)ethyltrimethoxysilane, 3-glycidoxypropyltrimethoxysilane, 3-glycidoxypropylmethyldiethoxysilane and 3-glycidoxypropyltriethoxysilane. Examples of a styrene silane coupling agent include p-styryltrimethoxysilane.

Examples of the amino silane coupling agent include N-2(aminoethyl)3-aminopropylmethyldimethoxysilane, N-2(aminoethyl)3-aminopropyltrimethoxysilane, N-2(aminoethyl)3-aminopropyltriethoxysilane, 3-aminopropyltrimethoxysilane, 3-aminopropyltriethoxysilane, 3-triethoxysilyl-N-(1,3-dimethyl-butylidene)propylamine and N-phenyl aminopropyltrimethoxysilane.

Examples of the ureido silane coupling agent include 3-ureidopropyltriethoxysilane.

Examples of further other surface treatment agents include those listed below. Examples of a chloropropyl silane coupling agent include 3-chloropropyltrimethoxysilane. Examples of a mercapto silane coupling agent include 3-mercaptopropylmethyldimethoxysilane and 3-mercaptopropyltrimethoxysilane. Examples of a sulfide silane coupling agent include bis(triethoxysilylpropyl)tetrasulfide. Examples of an isocyanate silane coupling agent include 3-isocyanatepropyltriethoxysilane. Examples of an aluminum coupling agent include acetoalkoxyaluminum diisopropylate.

The dispersion medium for use in dispersions used in the present invention is not particularly limited as long as the coated zirconia fine particles can be dispersed therein. For example, water or an organic compound can be used as the dispersion medium for use in dispersions.

When water is used as the dispersion medium for use in dispersions, the pH is preferably 2 to 5 or 9 to 13 from the viewpoint of dispersibility of the coated zirconia fine particles.

The organic compound as the dispersion medium for use in dispersions can be selected from a compound known as an organic solvent. Specific examples thereof can preferably include, for example, ethanol, isopropanol, butanol, cyclohexanol, methyl ethyl ketone, methyl isobutyl ketone, cyclohexanone, ethyl acetate, propyl acetate, butyl acetate, methyl cellosolve, cellosolve, butyl cellosolve, cellosolve acetate, tetrahydrofuran, 1,4-dioxane, n-hexane, cyclopentane, toluene, xylene, N,N-dimethylformamide, N,N-dimethylacetamide, dichloromethane, trichloroethane, trichloroethylene, hydrofluoroether and the like.

The dispersion medium for use in nanocomposites is not particularly limited as long as it is an organic compound such as, for example, a monomer, an oligomer, a resin (polymer) or the like in which the coated zirconia fine particles can be dispersed. For example, an aromatic ring-containing acrylate, an alicyclic skeleton-containing acrylate, a monofunctional alkyl (meth)acrylate, a polyfunctional alkyl (meth)acrylate, and polymers thereof can be used as the monomer, oligomer, resin or the like.

Examples of the aromatic ring-containing acrylate include phenoxyethyl acrylate, phenoxy 2-methylethyl acrylate, phenoxyethoxyethyl acrylate, 3-phenoxy-2-hydroxypropyl acrylate, 2-phenylphenoxyethyl acrylate, benzyl acrylate, phenyl acrylate, phenyl benzyl acrylate, paracumylphenoxyethyl acrylate and the like from the viewpoint of high refractive index.

Further, examples of the alicyclic skeleton-containing acrylate include 2-acryloyloxyethyl hexahydrophthalate, cyclohexyl acrylate, dicyclopentanyl acrylate, tetrahydrofurfuryl acrylate, dicyclopentanyl methacrylate, isobonyl methacrylate and the like from the viewpoint of having a high Abbe number and being preferable as an optical material.

Further, examples of the monofunctional alkyl (meth)acrylate include methyl (meth)acrylate, octyl (meth)acrylate, isostearyl (meth)acrylate, hydroxyethyl (meth)acrylate, hydroxyethyl (meth)acrylate, ethylene oxide-modified alkyl (meth)acrylate, propylene oxide-modified alkyl (meth)acrylate, hydroxyethyl (meth)acrylate, hydroxypropyl (meth)acrylate and the like from the viewpoint of low viscosity.

Further, examples of the polyfunctional alkyl (meth)acrylate include (i) bifunctional (meth)acrylates such as (poly)ethylene glycol di(meth)acrylate, (poly)propylene glycol di(meth)acrylate, neopentyl glycol di(meth)acrylate, 1,6-hexanediol di(meth)acrylate, 1,9-nonanediol di(meth)acrylate and the like, (ii) tri- and tetra-functional (meth)acrylates such as glycerol tri(meth)acrylate, trimethylolpropane tri(meth)acrylate, tri(meth)acrylate phosphate, pentaerythritol tetra(meth)acrylate and the like, (iii) an ethylene oxide- and/or propylene oxide-modified product of a compound selected from (i) and (ii) above, and the like from the viewpoint of being able to improve the hardness of hardened products.

In the method for producing a dispersion of coated zirconia fine particles and the method for producing a nanocomposite of the present invention, a dispersant can be used as necessary. The dispersant is not particularly limited as long as it is, for example, a compound including a group having an affinity for the coated zirconia fine particles, and preferable examples of the dispersant can include an anionic dispersant having an acid group such as a carboxylic acid, a sulfuric acid, a sulfonic acid, a phosphoric acid, a salt thereof or the like. Among these, a phosphate ester dispersant is preferable. The use amount of the dispersant is not particularly limited, but preferably 0.1 to 30 mass % relative to the coated zirconia fine particles.

### EXAMPLES

The following examples illustrate the coated zirconia fine particle and the method for producing the same of the present invention and the like, but the present invention is not limited to these examples.

Note that various kinds of instrumental analyses were performed by the following methods.

### (1) X-Ray Diffraction (XRD)

Measurements were carried out with an X-ray diffraction instrument (D8 ADVANCE/V) manufactured by Bruker AXS, and qualitative analysis or quantitative analysis by Rietveld analysis was performed (tetragonal, monoclinic and the like).

### (2) Measurement of the Amount of Coating Metal Compound in Coated Zirconia Fine Particles (XRF Analysis)

The amount of each element in coated inorganic fine particles was quantified with an X-ray fluorescence analyzer (S8 TIGER) manufactured by Bruker AXS.

### (3) Measurement of Specific Surface Area (SSA)

Using coated zirconia fine particles degassed at 150° C., the specific surface area thereof was measured by the BET method through adsorption and desorption of nitrogen gas with a full automatic BET specific surface area analyzer (Macsorb® HM model-1210) manufactured by Mountech Co., Ltd.

### (4) Measurement of Average Particle Size, and Evaluation of Particle Shape and Uniformity

Images of the particles were obtained at a magnification of 30,000 to 200,000 times by a transmission electron microscope (H-7600) manufactured by Hitachi High-Technologies Corporation, and the long diameters of 200 or more particles were measured, and the average value thereof was determined and used as the measured average particle size. The particle shape was evaluated on the basis of observations of the TEM images, and the uniformity was evaluated on the basis of the measured average particle size.

### (5) Evaluation of Uniformity of Surface Coating

Images of the particles were obtained at a magnification of 3,000 times by a field emission scanning electron microscope (SU8220) and an energy dispersive X-ray analyzer (EX-370X-MAX50) manufactured by Hitachi High-Technologies Corporation, and the elemental distribution was observed and evaluated through EDX mapping.

### [Preparation of Coated Zirconia Fine Particles]

### Example 1

Pure water was added to 27.7 g (225 mmol) of powder of zirconia fine particles with an average particle size of 10 nm (manufactured by KANTO DENKA KOGYO CO., LTD.) such that the powder concentration was 20 mass %, and the mixture was stirred with a mechanical stirrer for an hour, thereby preparing a zirconia water slurry. 1 mol/L yttrium nitrate aqueous solution equivalent to 13.5 mmol of yttrium nitrate was added dropwise and mixed to the slurry, and the mixture was stirred for an hour. Next, 25 mass % sodium hydroxide aqueous solution was added dropwise and mixed such that the degree of neutralization was 0.8 or more and the pH was 12 to 13, and the mixture was stirred for about an hour. The resultant slurry was subjected to suction filtration, and the obtained product was washed with water until Na was not detected by XRF spectrometry and thereafter dried at 150° C. until the moisture content was 1% or less. The obtained solid was ground in a mortar and sieved (75 μm mesh).

### Examples 2 to 13 and Comparative Example 1

Various types of coated zirconia were prepared in accordance with example 1 with the formulations shown in Table 1. Note that a commercially available zirconia fine particle which is mainly monoclinic was used as a raw material in example 6. Further, sodium carbonate was used for neutralization in example 7. Further, calcium chloride was used in place of yttrium nitrate in example 8. Further, the second compound was used in some examples.

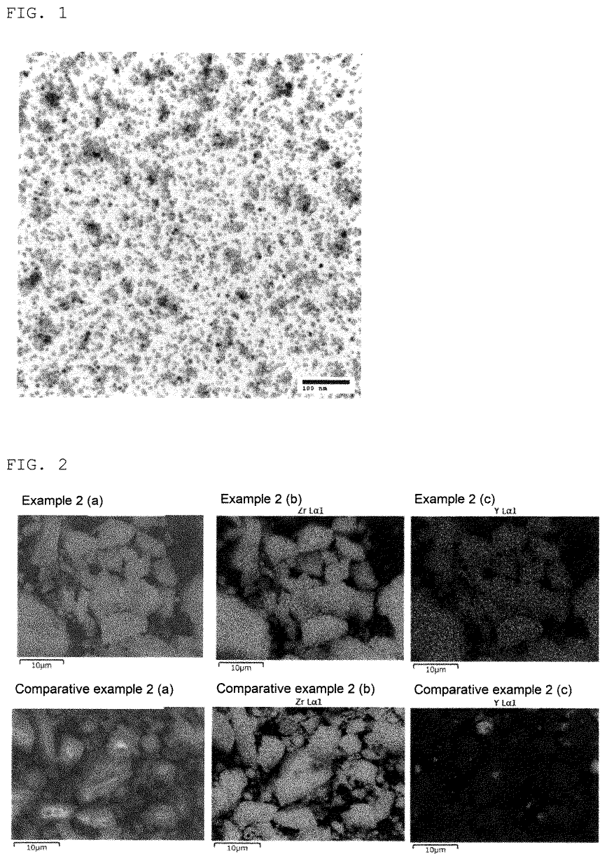

FIG. 1 shows a TEM image of coated zirconia fine particles of example 2. Further, FIG. 2 shows SEM-EDX mapping pictures of the coated zirconia fine particles of example 2. The TEM picture shows that the particles obtained in example 2 are spherical, and the measured average particle size indicates good uniformity.

### Comparative Example 2

Pure water was added to 27.7 g (225 mmol) of powder of zirconia fine particles with an average particle size of 5 to 10 nm (manufactured by KANTO DENKA KOGYO CO., LTD.) such that the concentration was 20 mass %, and the mixture was stirred with a mechanical stirrer for an hour. 3.1 g of yttria (Y₂O₃) was added to the obtained slurry including the zirconia fine particles, and the mixture was stirred for an hour. The resultant slurry was subjected to suction filtration, and the obtained product was washed with water and thereafter dried by heating at 150° C. until the moisture content was 1% or less. The obtained solid was ground in a mortar, and passed through a sieve with a mesh opening of 74 μm. FIG. 2 shows SEM-EDX mapping pictures of the coated zirconia of comparative example 2.

### [Sintering of Coated Zirconia Fine Particles and Variations in Crystal Structure]

The crystal structure of each of the coated zirconia fine particles obtained in examples 1 to 13 and comparative examples 1 to 2 after sintering at 1000° C. was evaluated in the following manner.

The coated zirconia fine particles were heated from 20° C. to 1,000° C. under an air atmosphere for 4 hours, and sintered at 1,000° C. for 3 hours. The crystal structure of the obtained powder was evaluated by X-ray diffraction (XRD) spectroscopy. Note that the crystal structure and other properties of the coated zirconia fine particles significantly vary depending on sintering conditions (temperature and time).

TABLE 1

| | | Coating compound | | | | | | | |
|---|---|---|---|---|---|---|---|---|---|
| | | (1) First | | (2) Second | | Coated zirconia fine particle | | | |
| | | compound | | compound | | | | XRD analysis | |
| | | | Pre- | | Pre- | Average | Specific | Tetra- | Mono- |
| | | | paration | | paration | particle | surface | gonal | clinic |
| | | | amount*¹ | | amount*² | size | area | ratio | ratio |
| | | Type | (mol %) | Type | (mol %) | (nm) | (m²/g) | (mass %) | (mass %) |
| Ex- | 1 | Y(OH)₃ | 6 | — | — | 10 | 136 | 90 | 10 |
| am- | | | | | | | | | |
| ple | 2 | Y(OH)₃ | 12 | — | — | 10 | 120 | 82 | 18 |
| | 3 | Y(OH)₃ | 18 | — | — | 10 | 120 | 83 | 17 |
| | 4 | Y(OH)₃ | 6 | Al(OH)₃ | 3 | 10 | 125 | 82 | 18 |
| | 5 | Y(OH)₃ | 12 | Al(OH)₃ | 6 | 10 | 125 | 90 | 10 |
| | 6 | Y(OH)₃ | 6 | Al(OH)₃ | 3 | 20 | 87 | 7 | 93 |
| | 7 | Y₂(CO₃)₃ | 6 | — | — | 10 | 130 | 81 | 19 |
| | 8 | Ca(OH)₂ | 12 | — | — | 10 | 134 | 89 | 11 |
| | 9 | Y(OH)₃ | 6 | Mg(OH)₂ | 5 | 10 | 136 | 90 | 10 |
| | 10 | Y(OH)₃ | 6 | Ca(OH)₂ | 3 | 10 | 128 | 90 | 10 |
| | 11 | Y(OH)₃ | 3 | — | — | 10 | 142 | 76 | 24 |
| | 12 | Y(OH)₃ | 24 | — | — | 10 | 117 | 82 | 18 |
| | 13 | Y(OH)₃ | 36 | — | — | 10 | 105 | 78 | 22 |
| Compar- | 1 | — | — | — | — | 10 | 147 | 85 | 15 |
| ative | 2 | Y₂O₃ | 6 | — | — | 10 | 130 | 76 | 24 |
| Example | | | | | | | | | |
| | | Coated zirconia fine particle | | | | | Sintering evaluation | | |
| | | XRF analysis | | | | | (1000° C.) | | |
| | | | Amount of | Amount of | Content | | Tetra- | Mono- | Impurity |
| | | Zr*² | metal | metal | ratio | | gonal | clinic | phase |
| | | (mass | element of | element of | (mol %) | | ratio | ratio | (XRD |
| | | %) | (1) (mass %) | (2) (mass %) | (1) | (2) | (mass %) | (mass %) | analysis) |
| Ex- | 1 | 91.0 | 8.9 | — | 10.0 | — | 42 | 58 | Not |
| am- | | | | | | | | | detected |
| ple | 2 | 84.3 | 15.6 | — | 19.0 | — | 95 | 5 | Not |
| | | | | | | | | | detected |
| | 3 | 78.5 | 21.5 | — | 28.0 | — | 93 | 7 | Not |
| | | | | | | | | | detected |
| | 4 | 90.7 | 8.7 | 0.7 | 10.0 | 2.4 | 91 | 9 | Not |
| | | | | | | | | | detected |
| | 5 | 82.0 | 16.7 | 1.2 | 20.8 | 5.0 | 99 | 1 | Not |
| | | | | | | | | | detected |
| | 6 | 91.0 | 8.3 | 0.7 | 9.4 | 2.6 | 95 | 5 | Not |
| | | | | | | | | | detected |
| | 7 | 93.3 | 6.6 | — | 3.6 | — | 27 | 73 | Not |
| | | | | | | | | | detected |
| | 8 | 95.1 | 4.8 | — | 11.4 | — | 48 | 52 | Not |
| | | | | | | | | | defected |
| | 9 | 90.8 | 8.5 | 0.6 | 9.6 | 2.5 | 44 | 56 | Not |
| | | | | | | | | | detected |
| | 10 | 89.5 | 8.6 | 1.6 | 9.8 | 4.2 | 57 | 43 | Not |
| | | | | | | | | | detected |
| | 11 | 95.6 | 4.3 | — | 4.8 | — | 20 | 80 | Not |
| | | | | | | | | | detected |
| | 12 | 72.9 | 27.1 | — | 38.2 | — | 92 | 8 | Y₂O₃ |
| | 13 | 63.3 | 36.3 | — | 59.4 | — | 99 | 1 | Y₂O₃ |
| Compar- | 1 | 99.9 | — | — | 0 | — | 0 | 100 | Not |
| ative | | | | | | | | | detected |
| Example | 2 | 83.6 | 16.3 | — | 10.0 | — | 64 | 36 | Y₂O₃ |

*1 mol % is mol % relative to the amount of zirconia, and shown is the amount of a coating compound based on the type and preparation amount of a raw material, the type of a neutralizing agent, or the like
*2 a very small amount of Hf is included, and the amount including that of Hf is shown as the amount of Zr by mass %

The zirconia fine particle of comparative example 1 which was not coated with a metal compound had a tetragonal ratio of 0%, that is, a monoclinic ratio of 100% after sintering at 1000° C., whereas those of examples 1 to 13 had tetragonal ratio values of 20% or more.

Examples 1 to 3 show that as the content ratio of the coating compound yttrium hydroxide is increased, the tetragonal ratio after sintering is increased. Particularly, examples 2 and 3 containing the coating compound equivalent to 12 mol % or more of yttrium hydroxide respectively have tetragonal ratios of 95% and 93% after sintering under these sintering conditions, and this leads to the inference that Y enters the zirconia crystal lattice and effectively acts as a tetragonal stabilizing element.

The particle of comparative example 2 which was coated with yttria directly and not via a Y ion has a tetragonal ratio of 64%, which is about 30% lower than that of example 2 in which the surface coating was made via a Y ion aqueous solution. The non-uniform Y coating shown in the SEM-EDX mapping pictures in FIG. 2 is considered to be a reason for this, and unstable physical properties are also easily inferred. In addition, there is a concern that the formation of an impurity phase derived from the stabilizer may affect the degradation of the strength and other properties of the sintered product.

Examples 4 to 10 show that not only hydroxides and carbonates (also including hydrates of carbonates) of Y, but also those of Mg, Ca, and Al can be used as metal compounds that act as stabilizers. Further, a combination of these metal compounds is also possible.

Example 6 shows that even when fine particles (particle size: 20 nm) which are mainly monoclinic are used as a raw material fine particle, the crystal structure after sintering at 1,000° C. has a tetragonal ratio of 95%, which is equivalent to the result of example 4.

Example 11 shows that even if the preparation amount of yttrium nitrate was reduced, the zirconia fine particles could be coated.

Examples 12 and 13 show that even if the preparation amount of yttrium nitrate was increased, the zirconia fine particles could be coated. It was inferred from the results of XRD pattern observations of yttria in examples 12 and 13 that yttria not constituting a solid solution was also formed.

### Examples 14 to 21 and Comparative Example 3

The effect of the size of zirconia fine particles used in a coating step (hereinafter, raw material fine particle) is explained. Considering that fine particles with a wide granularity distribution were also used as a raw material, the size of the particles was evaluated here in terms of the specific surface area.

Coated zirconia fine particles were obtained respectively from raw material fine particles with the specific surface areas shown in Table 2 in accordance with example 2. A raw material fine particle of example 14 (specific surface area: 140 m²/g) was sintered to obtain the raw material fine particles with the adjusted specific surface areas. A coating compound equivalent to 12 mol % of yttrium hydroxide was uniformly used. The obtained coated zirconia fine particles were sintered at 1000° C. in the same manner as in examples 1 to 13, and the crystal structure thereof was evaluated by XRD spectroscopy. The tetragonal ratios after sintering and the specific surface areas of the raw material fine particles are shown in Table 2.

TABLE 2

| | | | | | | | | | | Comparative |
|---|---|---|---|---|---|---|---|---|---|---|
| | Example | | | | | | | | | example |
| | 14 | 2 | 15 | 16 | 17 | 18 | 19 | 20 | 21 | 3 |
| Specific surface area of raw | 140 | 130 | 111 | 94 | 75 | 67 | 54 | 41 | 22 | 7 |
| material ZrO₂*¹ (m²/g) | | | | | | | | | | |
| Specific surface area of | 127 | 120 | 104 | 91 | 74 | 71 | 60 | 48 | 33 | 17 |
| coated ZrO₂*¹ | | | | | | | | | | |
| (m²/g) | | | | | | | | | | |
| Tetragonal ratio after | 89 | 95 | 93 | 93 | 90 | 78 | 72 | 58 | 28 | 12 |
| sintering*² (mass %) | | | | | | | | | | |

*¹Specific surface area of zirconia fine particles used in coating step or zirconia fine particles after coating (m²/g)
*²Tetragonal ratio of coated zirconia fine particles after sintering at 1000° C. for 3 hours (mass %)

Table 2 shows that a raw material fine particle with a larger specific surface area has a higher tetragonal ratio. Under these sintering conditions, particularly examples 14 to 17, that is, those with a specific surface area falling within the range of 75 to 140 m²/g have a tetragonal ratio of approximately 90%, which means that Y acts more effectively as a tetragonal stabilizing element. This is considered to be because the smaller the particle size is, the more uniformly Y exists in a solid solution at the molecular level.

### Reference Examples 1 to 4

The degree of densification of a sintered product prepared from a coated zirconia fine particle was evaluated.

### [Preparation of Sintered Product]

4 g of powder of coated zirconia fine particles was compacted with a uniaxial pressing machine at a pressure of 0.5 t, thereby preparing a molded product. The relative density (%) of the molded product before and after sintering, which was calculated from the density of the molded product based on measurements with a vernier caliper divided by the theoretical density of zirconia (6.0 g/cm³), was used to evaluate the densification. The sintering temperatures were 200° C. for an hour, 1000° C. for 3 hours and 1200° C. for 3 hours, and the temperate rising rates were 4° C./rain from 20° C. to 1000° C., and 2° C./min from 1000° C. to 1200° C. Table 3 shows the relative density of the sintered product and the like.

The zirconia fine particle not coated with a stabilizer (comparative example 1), the coated zirconia fine particle of example 1, the coated zirconia fine particle of example 4 and a commercially available partially stabilized zirconia were used in reference examples 1, 2, 3 and 4, respectively.

TABLE 3

| | | Coated zirconia fine particle | | | | | | | | |
|---|---|---|---|---|---|---|---|---|---|---|
| | | | | | | | | | XRD | |
| | | | Coating compound | | | | | | analysis | |
| | | | (1) First | | (2) Second | | Aver- | | Tetra- | Mono- |
| | | | compound | | compound | | age | Specific | gonal | clinic |
| | | | | Preparation | | Preparation | particle | surface | ratio | ratio |
| | | | | amount | | amount | size | area | (mass | (mass |
| | | Type | Type | (mol %) | Type | (mol %) | (nm) | (m²/g) | %) | %) |
| Reference | 1 | Comparative | — | — | — | — | 10 | 147 | 85 | 15 |
| example | | example 1 | | | | | | | | |
| | 2 | Example 1 | Y(OH)₃ | 6 | — | — | 10 | 136 | 90 | 10 |
| | 3 | Example 4 | Y(OH)₃ | 6 | Al(OH)₃ | 3 | 10 | 125 | 82 | 18 |
| | 4 | Commercially | — | — | — | — | 80 | 15 | 58 | 43 |
| | | available | | | | | | | | |
| | | product | | | | | | | | |
| | | Coated zirconia fine particle | | | | | | | | |
| | | XRF analysis | | | | | | | | |
| | | Amount | Amount | | | | | | | |

| | | of | of | | | Sintered product | | |
|---|---|---|---|---|---|---|---|---|
| | | metal | metal | | | | Relative | |
| | | element | element | Content | | | density*¹ (%) | |
| | | of (1) | of (2) | ratio (mol %) | | | Before | After |
| | | (mass %) | (mass %) | (1) | (2) | State | sintering | sintering |
| Reference | 1 | — | — | — | — | Molding not | — | — |
| example | | | | | | possible | | |
| | 2 | 8.9 | — | 10.0 | — | No | 28.7 | 39.4 |
| | | | | | | abnormality | | |
| | 3 | 8.7 | 0.7 | 10.0 | 2.4 | No | 28.1 | 85.0 |
| | | | | | | abnormality | | |
| | 4 | 10.1 | 0.2 | 5.8*² | 0.4*² | No | 36.2 | 79.2 |
| | | | | | | abnormality | | |

*1 relative density (%)=(W/V)/d₀×100

W: mass of powder of coated zirconia fine particles (g)

V: volume of molded product (cm³)

d₀: theoretical density of zirconia (=6.0 g/cm³)

*2 the content ratio of (1) and that of (2) in reference example 4 using the commercially available product are expressed in terms of those of Y₂O₃ and Al₂O₃, respectively

In contrast to reference example 1 in which a molded product itself could not be prepared from the zirconia fine particles not coated with a stabilizer, a sintered product could be prepared without cracking and fracture from the zirconia fine particles coated only with yttria in reference example 2.

A sintered product prepared in reference example 3 from the zirconia fine particles whose surface was coated with yttrium hydroxide as well as aluminum hydroxide could be even more densified than that of example 4 using the commercially available product.

### Example 22

100 g of powder of coated zirconia fine particles obtained in example 4 was mixed into 500 g of pure water, and acetic acid was added dropwise to make the pH 4, thereby preparing a mixed liquid. The obtained mixed liquid was stirred with a dispersing stirrer for 30 minutes to be coarsely dispersed. The obtained mixed liquid was dispersed by a media wet dispersing device. The mixed liquid was dispersed while checking the particle size during the process, thereby obtaining the dispersion of example 22. The dispersed particle size of the coated zirconia fine particles in the obtained dispersion was measured by the method described later. Further, a dispersion of reference example 5 was similarly produced with raw material uncoated zirconia fine particles in place of the coated zirconia fine particles of example 4, and evaluated in the same manner. The results are shown in Table 4.

### Example 23

120 g of powder of the coated zirconia fine particles obtained in example 4, 30.0 g of 3-methacryloyloxypropyltrimethoxysilane (product name: KBM-503, manufactured by Shin-Etsu Chemical Co., Ltd.) and 250 g of methyl ethyl ketone (MEK) were mixed and stirred with a dispersing stirrer for 30 minutes to be coarsely dispersed. The obtained mixed liquid was dispersed by a media wet dispersing device. The mixed liquid was dispersed while checking the particle size during the process, thereby obtaining the dispersion of example 23. The dispersed particle size of the coated zirconia fine particles in the obtained dispersion was measured by the method below. Further, a dispersion of reference example 6 was similarly produced with raw material uncoated zirconia fine particles in place of the coated zirconia fine particles of example 4, and evaluated in the same manner. The results are shown in Table 4.

### <Method for Measuring Dispersed Particle Size of Coated Zirconia Fine Particles in Dispersion>

The dispersed particle size of the coated or uncoated zirconia fine particles in a dispersion after a lapse of one day from the preparation (stored at 25° C.) was measured at 25° C. with the dynamic light scattering particle size analyzer LB-500 manufactured by HORIBA, Ltd. The results are shown in Table 4. It was found that the coated zirconia fine particles of the present invention could be as well dispersed in the prepared dispersion as the uncoated zirconia fine particles.

TABLE 4

| | | Dispersion | | | Evaluation | |
|---|---|---|---|---|---|---|
| | | | | Solids | Dispersed | |
| | | | Dis- | content | particle | Dis- |
| | | Dispersed | persion | concentration | size | persion |
| | | particle | medium | (mass %) | (nm) | state |
| Example | 22 | Example 4 | Water | 20 | 11 | Good |
| | 23 | Example 4 | MEK | 30 | 12 | Good |
| Reference | 5 | ZrO₂ | Water | 20 | 11 | Good |
| | | (not coated) | | | | |
| example | 6 | ZrO₂ | MEK | 30 | 11 | Good |
| | | (not coated) | | | | |

1. A coated zirconia fine particle comprising a zirconia fine particle and a coating layer coating the surface of the fine particle,
wherein the coating layer comprises one or more metal elements selected from Mg, Ca, Al and rare-earth elements, and
the coated zirconia fine particle has an average particle size of 3 to 100 nm and a specific surface area of 20 to 500 m²/g.

2. The coated zirconia fine particle according to claim 1, wherein the coating layer comprises a compound comprising one or more metal elements selected from Mg, Ca, Al and rare-earth elements.

3. The coated zirconia fine particle according to claim 1, wherein the coating layer comprises one or more compounds selected from hydroxides of one or more metal elements selected from Mg, Ca, Al and rare-earth elements, carbonate salts of the metal elements, and oxides of the metal elements.

4. The coated zirconia fine particle according to claim 1, wherein the coating layer comprises one or more compounds selected from hydroxides of one or more metal elements selected from Mg, Ca, Al and Y, carbonate salts of the metal elements, and oxides of the metal elements.

5. The coated zirconia fine particle according to claim 1, wherein the coating layer comprises a compound comprising one or more metal elements selected from Mg, Ca, Al and rare-earth elements in an amount of 3 to 45 mol % relative to the amount of zirconia in the zirconia fine particle.

6. A method for producing coated zirconia fine particles comprising reacting, in an aqueous dispersion containing zirconia fine particles, ions of one or more metal elements selected from Mg, Ca, Al and rare-earth elements with an additive that reacts with the ions to form a water-insoluble compound, and precipitating a compound comprising the metal elements on the surface of the zirconia fine particles to obtain the coated zirconia fine particles.

7. The method for producing coated zirconia fine particles according to claim 6, wherein the additive is an alkali agent.

8. The method for producing coated zirconia fine particles according to claim 6, wherein, after obtaining the coated zirconia fine particles, the additive is removed from the coated zirconia fine particles.

9. The method for producing coated zirconia fine particles according to claim 6, wherein, after obtaining the coated zirconia fine particles, the coated zirconia fine particles are washed with water.

10. The method for producing coated zirconia fine particles according to claim 6, wherein the obtained coated zirconia fine particles are dried at 200° C. or less.

11. The method for producing coated zirconia fine particles according to claim 6, wherein the zirconia fine particles have an average particle size of 3 to 100 nm.

12. The method for producing coated zirconia fine particles according to claim 6, wherein the aqueous dispersion, an aqueous solution of a compound comprising the metal elements and the additive are mixed together.

13. A method for producing a zirconia sintered product comprising, a step of producing the coated zirconia fine particle by the method according to claim 6, and a step of sintering the produced coated zirconia fine particle.

14. A method for producing a dispersion of coated zirconia fine particles comprising, a step of dispersing the coated zirconia fine particles according to claim 1 in a dispersion medium.

15. A method for producing a nanocomposite comprising, a step of dispersing the coated zirconia fine particles according to claim 1 in a dispersion medium.
